(19) United States
(12) Patent Application Publication
(10) Pub. No.: US 2011/0032175 A1
(43) Pub. Date: Feb. 10, 2011

(54) DISPLAY APPARATUS AND COMPLEX ENTERTAINMENT APPARATUS INCLUDING THE SAME

(75) Inventor: Tae Gil Kang, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd, Suwon-si (KR)

(21) Appl. No.: 12/842,089

(22) Filed: Jul. 23, 2010

(30) Foreign Application Priority Data
Aug. 7, 2009 (KR) 2009-72694

(51) Int. Cl. G09G 5/00

(52) U.S. Cl. 345/1.3

(57) ABSTRACT

A display apparatus and a complex entertainment apparatus including the same. The display apparatus includes a main display unit and a sub display unit. The sub display unit is positioned at the rear of the main display unit. When the main display unit is slid up, the sub display unit moves frontward to constitute a single screen together with the main display unit. The main display unit is pulled to the sub display unit by a lever unit. The complex entertainment apparatus is operated in a picture mode in a state in which the main display unit is slid up and in a playback mode or a game mode in a state in which the main display unit is slid down. The size of the screen is adjusted according to use.

### CROSS-REFERENCE TO RELATED APPLICATIONS

This application claims priority under 35 U.S.C. §119 of Korean Patent Application No. 2009-0072694, filed on Aug. 7, 2009 in the Korean Intellectual Property Office, the disclosure of which is incorporated herein by reference.

### BACKGROUND

1. Field of the Invention

Exemplary embodiments of the present general inventive concept relate to a display apparatus and a complex entertainment apparatus including a display apparatus having operation modes changeable according to change of screen size.

2. Description of the Related Art

Generally, a display apparatus is used in various kinds of equipment for various purposes.

When used in a digital camera, the display apparatus allows a user to watch a picture entering through a camera lens at the rear of a camera body in real time when taking still pictures or motion pictures. Also, still pictures or motion pictures may be played on the display apparatus.

When used in a portable game console, the user may enjoy games while watching movement of a picture on a screen of the display apparatus.

A multi-function apparatus having a function as the digital camera and a function as the portable game console is expected.

### SUMMARY

The present general inventive concept provides a display apparatus, screen size of which is variable, and a complex entertainment apparatus including the same.

Embodiments of the present general inventive concept provide a display apparatus having operation modes changeable according to variable screen size and a complex entertainment apparatus including the same.

Embodiments of the present general inventive concept provide a display apparatus that prevents the occurrence of a gap due to increase of screen size and a complex entertainment apparatus including the same. Additional features and utilities of the present general inventive concept will be set forth in part in the description which follows and, in part, will be obvious from the description, or may be learned by practice of the general inventive concept.

Embodiments of the present general inventive concept include a display apparatus that includes a case, a main display unit to slide at one surface of the case, a sub display unit to move frontward to the surface of the case or move rearward from the surface of the case, and a display coupling unit to move the main display unit to the sub display unit on the surface of the case.

The display apparatus may further include an elevation unit to elevate the sub display unit, and the elevation unit may include a front cam formed at a rear of the sub display unit and a rear cam disposed at a rear of the front cam.

The display coupling unit may include at least one lever unit to be rotated by a rectilinear motion of the rear cam.

The lever unit may include a drive pin coupled to the rear cam, a stationary pin coupled to the case, and a rotary pin to pull the main display unit to the sub display unit.

The rotary pin may be caught by a lever protrusion formed at a lower side of a rear of the main display unit.

The front and rear cams may have corresponding inclines, and the front cam may be moved frontward or rearward by a rectilinear motion of the rear cam.

The display apparatus may further include a drive unit to rectilinearly move the rear cam, and the drive unit may include a motor to provide drive force and a power transmission unit to transmit the drive force provided by the motor to the rear cam.

The power transmission unit may include pluralities of gears and screws.

The power transmission unit may include a first gear directly connected to the motor, a second gear engaged with the first gear such that a rotation axis of the second gear is perpendicular to that of the first gear, a first screw having the same rotation axis as the second gear, a third gear engaged with the first screw such that a rotation axis of the third gear is perpendicular to that of the first screw, and a second screw having the same rotation axis as the third gear to directly transmit drive force to the rear cam.

The main display unit may include an anti-slip part to prevent slip during sliding of the main display unit.

The main display unit may be provided at a rear thereof with a spring to connect the main display unit and the case.

The spring may include a spiral spring.

The main display unit may be provided at opposite sides of a rear thereof with slide bars, and the case may include guide rails to guide sliding motions of the slide bars.

Embodiments of the present general inventive concept include a display apparatus that includes a case, a main display unit constituting a screen, a sub display unit to move to one side of the main display unit according to movement of the main display unit such that the main display unit and the sub display unit are arranged side by side, and a lever unit to connect the main display unit and the sub display unit, and the lever unit may move the main display unit to the sub display unit during movement of the sub display unit.

Embodiments of the present general inventive concept include a display apparatus that includes a case, a main display unit to slide on one surface of the case in a first direction, a sub display unit to move frontward and rearward in a second direction perpendicular to the first direction, and a gap restraint part disposed with at least one of the main and sub display units to restrain occurrence of a gap between the main display unit and the sub display unit when the main display unit and the sub display unit constitute the same plane.

Embodiments of the present general inventive concept include a complex entertainment apparatus that includes a display apparatus constituting a screen, the display apparatus includes a main display unit to slide in a first direction and a sub display unit to move frontward and rearward in a second direction perpendicular to the first direction, and the complex entertainment apparatus has operation modes changeable according to a sliding motion of the main display unit.

The operation modes may include a picture mode in which still pictures or motion pictures are captured, a playback mode in which still pictures or motion pictures are played on the screen of the display apparatus, and a game mode in which games are played on the screen.

The complex entertainment apparatus may be operated in the picture mode in a state in which the main display unit is slid down and in the playback mode or the game mode in a state in which the main display unit is slid up.

The complex entertainment apparatus may be automatically turned on and operated in the playback mode or the game mode when the main display unit is slid up in a state in which the complex entertainment apparatus is off.

The complex entertainment apparatus may be automatically turned off when the main display unit is slid down while the complex entertainment apparatus is operated in the playback mode or the game mode.

The operation mode may be switched to the playback mode or the game mode when the main display unit is slid up while the complex entertainment apparatus is operated in the picture mode.

Embodiments of the present general inventive concept further include an interactive image display apparatus including a case, a main display unit to display at least one image in a picture mode while aligned with the perimeter of the case, a sub display unit to display at least one image in a playback or game mode while positioned on a plane shared with the main display unit, and a drive unit to power at least one cam to move the sub display unit in a direction perpendicular the plane shared with the main display unit.

Embodiments of the present general inventive concept further include a display device including a case, a main display unit to display an image thereon and to slide in a lengthwise direction, a sub display unit to display an image thereon and to travel in a vertical direction perpendicular to the lengthwise direction, and a pair of cams to move the sub display unit in the vertical direction in order to position an edge of the sub display unit flush with an edge of the main display unit.

Embodiments of the present general inventive concept further include a display apparatus including a case, a plurality of display units having their respective screens to display an image thereon, and a driving unit to drive the plurality of display units with respect to the case such that the respective screens are disposed on a plane to display the image.

### BRIEF DESCRIPTION OF THE DRAWINGS

These and/or other features and utilities of the present general inventive concept will become apparent and more readily appreciated from the following description of the exemplary embodiments, taken in conjunction with the accompanying drawings of which:

FIG. 1 is an exterior perspective view illustrating a complex entertainment apparatus according to an exemplary embodiment of the present general inventive concept;

FIG. 2 is a perspective view illustrating the structure of an elevation unit in the complex entertainment apparatus;

FIG. 3 is a sectional view taken along line I-I′ of FIG. 1;

FIG. 4 is a sectional view taken along line II-II′ of FIG. 1;

FIG. 5 is a sectional view taken along line III-III′ of FIG. 1;

FIGS. 6A to 6C are exterior perspective views illustrating a sequence of up-sliding motions of a main display unit;

FIGS. 7A to 7C are sectional views illustrating the sequence of up-sliding motions of the main display unit when viewed from line I-I′ of FIG. 1;

FIGS. 8A to 8D are sectional views illustrating the sequence of up-sliding motions of the main display unit when viewed from line II-II′ of FIG. 1; and

FIGS. 9A and 9B are sectional views illustrating the sequence of up-sliding motions of the main display unit when viewed from line III-III′ of FIG. 1.

FIG. 10 illustrates the controller and certain components within the controller's domain.

FIG. 11A illustrates the main display unit displaying an image with the sub display unit beneath the main display unit.

FIG. 11B illustrates the main display unit arranged side by side with the sub display unit.

### DETAILED DESCRIPTION OF THE EXEMPLARY EMBODIMENTS

Reference will now be made in detail to the exemplary embodiments of the present general inventive concept, examples of which are illustrated in the accompanying drawings, wherein like reference numerals refer to like elements throughout. The exemplary embodiments are described below in order to explain the present general inventive concept by referring to the figures.

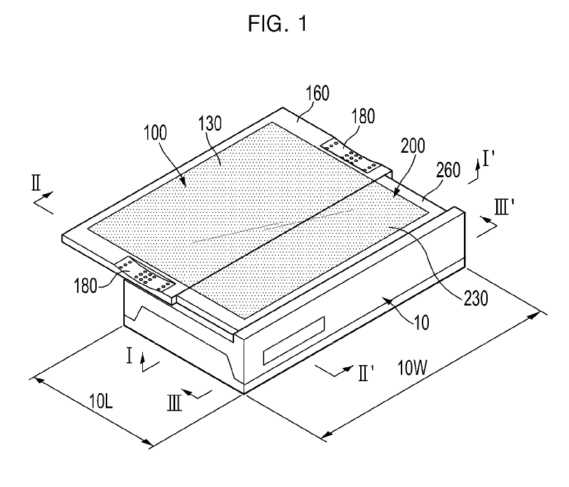

FIG. 1 is an exterior perspective view illustrating a complex entertainment apparatus 1 according to an exemplary embodiment of the present general inventive concept.

As illustrated in FIG. 1, the complex entertainment apparatus 1 may include a case 10 constituting an external appearance thereof, a main display unit 100 configured to perform a sliding motion, and a sub display unit 200 configured to be elevated according to the sliding motion of the main display unit 100. The length of case 10 is represented by 10L while the width of case 10 is represented by 10W in FIG. 1.

The complex entertainment apparatus 1 is an apparatus that may enable a user to enjoy various forms of entertainment. In this exemplary embodiment, the complex entertainment apparatus 1 may serve as a digital camera and a portable game console. However, exemplary embodiments of the present general inventive concept are not limited thereto. For example, the complex entertainment apparatus 1 may serve as a mobile phone, an MP3 player, or other various kinds of equipment using a display apparatus.

The case 10 may constitute an external frame of the complex entertainment apparatus 1. In the case 10 may be mounted various kinds of parts (not illustrated) to perform operations of the digital camera and the portable game console.

The main display unit 100 may include a main display module 130 to display a picture on a screen 130a and a main module case 160 to receive the main display module 130.

The main display module 130 may be manipulated by a user in a touch manner using keys or icons displayed on a touch screen 130a or a key pad formed on the main display module 130, sub display module 230, or case 10.

A thin film transistor liquid crystal display (TFT LCD) may be used as a display device of the main display module 130. Alternatively, an active matrix organic light emitting diode (AMOLED) may be used. Unlike the LCD to which back light is irradiated, the AMOLED is a self-emitting display device. The AMOLED has a motion picture response time equivalent to 1000 times or more that of the TFT LCD. Also, the AMOLED may exhibit a wider color reproduction range and higher contrast ratio than the TFT LCD.

The main module case 160, receiving the main display module 130, may constitute part of the external appearance of the complex entertainment apparatus 1. Anti-slip parts 180 may be formed at opposite sides of the main module case 160.

Each of the anti-slip parts 180 may be configured such that a plurality of protrusions are formed on a depression of the main module case 160. When a user slides the main display unit 100 up or down, the anti-slip parts 180 may be gripped by the user to prevent slip.

The slide structure of the main display unit 100 will be described later.

The sub display unit 200 may move frontward to be exposed when the main display unit 100 is slid up. The sub display unit 200 may include a sub display module 230 to display a picture or a screen 230a thereof and a sub module case 260 to receive the sub display module 230.

The sub display module 230 may be manipulated by a user in a touch manner using keys or icons displayed on a touch screen 130a or a key pad formed on the main display module 130, sub display module 230, or case 10. A TFT LCD may be used as a display device of the sub display module 230. Alternatively, an AMOLED may be used.

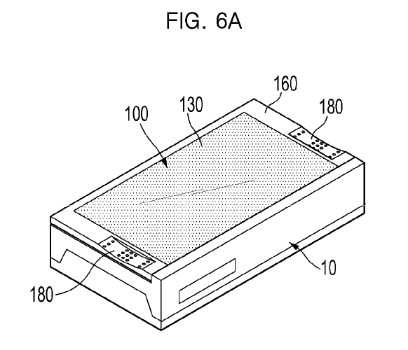

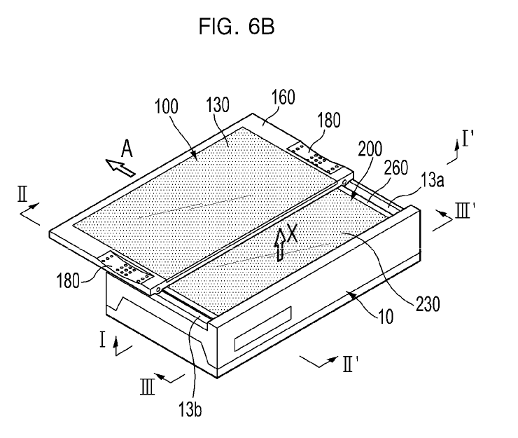

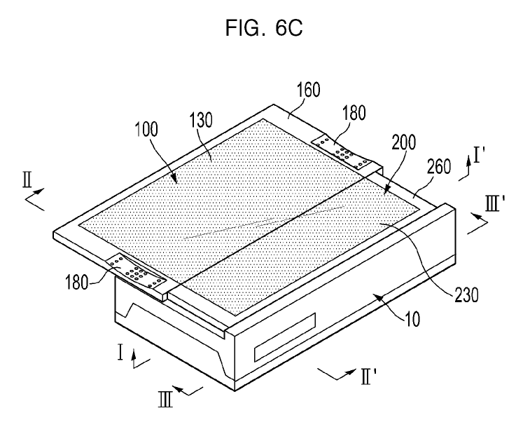

The sub module case 260, receiving the sub display module 230, may be exposed when the sub display unit 200 moves up from within the case 10 in an “X” direction, as illustrated in FIG. 6B.

Hereinafter, the internal structure of the complex entertainment apparatus 1 in a state in which the main display unit 100 is slid up will be described.

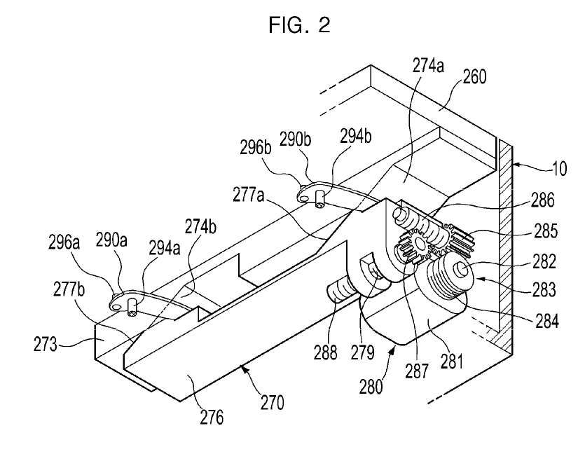

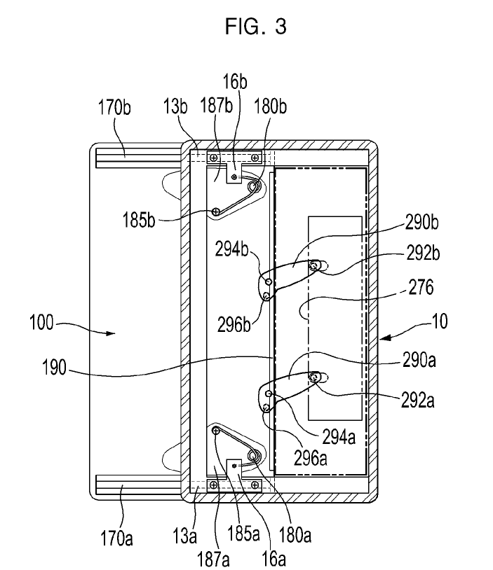

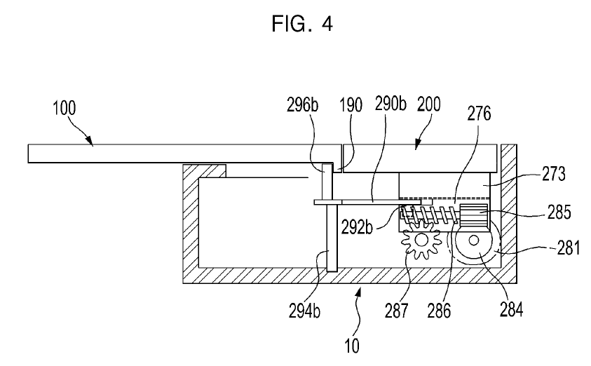

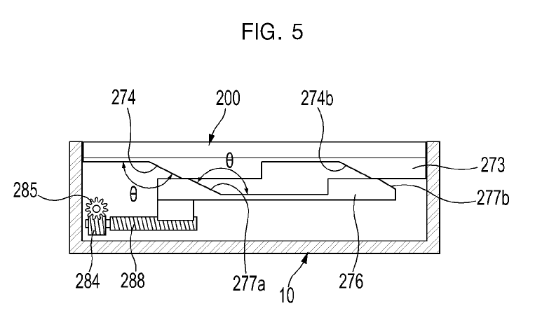

FIG. 2 is a perspective view illustrating the structure of an elevation unit in the complex entertainment apparatus, FIG. 3 is a sectional view taken along line I-I′ of FIG. 1, FIG. 4 is a sectional view taken along line II-II′ of FIG. 1, and FIG. 5 is a sectional view taken along line III-III′ of FIG. 1.

As illustrated in FIG. 2, an elevation unit 270 may be provided at the rear of the sub display unit 200 to elevate the sub display unit 200 from within the case 10 in an “X” direction, as illustrated in FIG. 6B.

The elevation unit 270 may include a front cam 273 integrally formed at the rear of the sub display unit 200 and a rear cam 276 disposed at the rear of the front cam 273.

The front cam 273 may have inclines 274a and 274b. The rear cam 276 may have inclines 277a and 277b. The inclines 274a and 274b of the front cam 273 may correspond to the inclines 277a and 277b of the rear cam 276, respectively. The angle of inclination of inclines 274a, 274b, 277a, and 277b are represented by θ in FIG. 5.

In front of the rear cam 276 may be provided a display coupling unit to move the main display unit 100 to the sub display unit 200. The display coupling unit may include lever units 290a and 290b configured to be rotated by a rectilinear motion of the rear cam 276. The lever units 290a and 290b will be described later.

At one side of the rear cam 276 is provided a drive unit 280 to rectilinearly move the rear cam 276.

The drive unit 280 may include a motor 281 to provide drive force for a rectilinear motion and a power transmission unit 283 to transmit the drive force provided by the motor 281 to the rear cam 276.

The power transmission unit 283 may constitute a combination of gears and screws.

That is, the power transmission unit 283 may include a first gear 284 directly connected to a motor shaft 282 such that the first gear 284 may rotate simultaneously with the motor shaft 281, a second gear 285 engaged with the first gear 284 such that a rotation axis of the second gear 285 is perpendicular to that of the first gear 284, a first screw 286 having the same rotation axis as the second gear 285 such that the first screw 286 rotates simultaneously with the second gear 285, a third gear 287 engaged with the first screw 286 such that a rotation axis of the third gear 287 is perpendicular to that of the first screw 286, and a second screw 288 having the same rotation axis as the third gear 287 to directly transmit drive force to the rear cam 276.

The second screw 288 may be coupled to a nut 279 formed in a lower part of the rear cam 276. Upon rotation of the second screw 288, rotational force may be transmitted to the nut 279, and the rear cam 276 may perform a rectilinear motion.

The interior structure of the complex entertainment apparatus 1 will be described in more detail with reference to FIGS. 3 to 5. FIGS. 3 to 5 illustrate sections of the interior structure of the complex entertainment apparatus 1 at various positions in a state in which the main display unit 100 is slid up.

The main display unit 100 may be provided at opposite sides of the rear thereof with slide bars 170a and 170b. Guide rails 13a and 13b corresponding to the slide bars 170a and 170b may be formed at the case 10. The guide rails 13a and 13b may guide sliding motions of the slide bars 170a and 170b.

Also, the main display unit 100 may be provided at opposite sides of the rear thereof with springs 180a and 180b to assist smooth up-sliding and down-sliding motions of the main display unit 100.

The springs 180a and 180b may be embodied by thin spiral springs to obtain a thin finished product. However, the springs 180a and 180b are not limited thereto. For example, various kinds of springs, such as a torsion spring, may be used.

One end of the spring 180a and one end of the spring 180b may be coupled to the rear of the main display unit 100 by fixing bolts 185a and 185b, respectively. The other end of the spring 180a and the other end of the spring 180b may be caught by spring fixing parts 16a and 16b of the case 10, respectively.

The springs 180a and 180b may move respectively in spring receiving parts 187a and 187b formed at opposite sides of the rear of the main display unit 100 according to up-sliding and down-sliding motions of the main display unit 100. The spring receiving parts 187a and 187b may be depressed in the rear of the main display unit 100 by a predetermined depth. The spring receiving parts 187a and 187b may be formed in a fan shape over a range in which the springs 180a and 180b move.

The lever units 290a and 290b may prevent the occurrence of a gap between the main display unit 100 and the sub display unit 200 in a state in which the main display unit 100 is slid up.

The lever units 290a and 290b may be formed generally in a sectional shape of ‘┐’ as illustrated in FIGS. 2, 3, and 7A-7C. The lever units 290a and 290b may include drive pins 292a and 292b coupled to the front of the rear cam 276, stationary pins 294a and 294b coupled to the case 10, and rotary pins 296a and 296b to pull the main display unit 100 to the sub display unit 200, respectively.

The drive pins 292a and 292b may be are connected to the rear cam 276 to perform rectilinear motions along with the rear cam 276. The stationary pins 294a and 294b may be coupled to the case 10 to serve as rotational centers of the lever units 290a and 290b when the drive pins 292a and 292b perform rectilinear motions. The rotary pins 296a and 296b may pull the main display unit 100 to the sub display unit 200 by rotations of the lever units 290a and 290b, while contacting a lever protrusion 190 formed at the lower side of the rear of the main display unit 100, to prevent the occurrence of a gap between the main display unit 100 and the sub display unit 200. That is, upon rotation of the lever units 290a and 290b, the rotary pins 296a and 296b may be caught by the lever protrusion 190, with the result that the main display unit 100 is pulled to the sub display unit 200.

Hereinafter, the operation of the complex entertainment apparatus 1 will be described in detail with reference to the accompanying drawings.

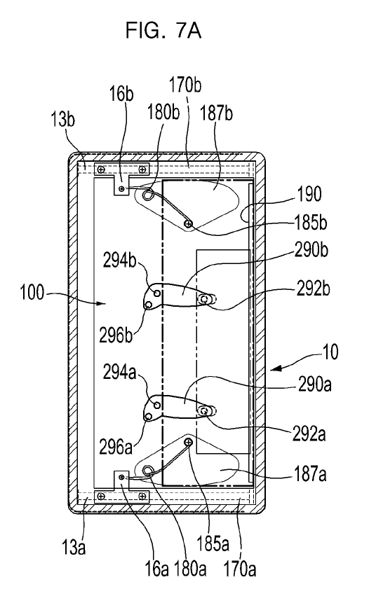

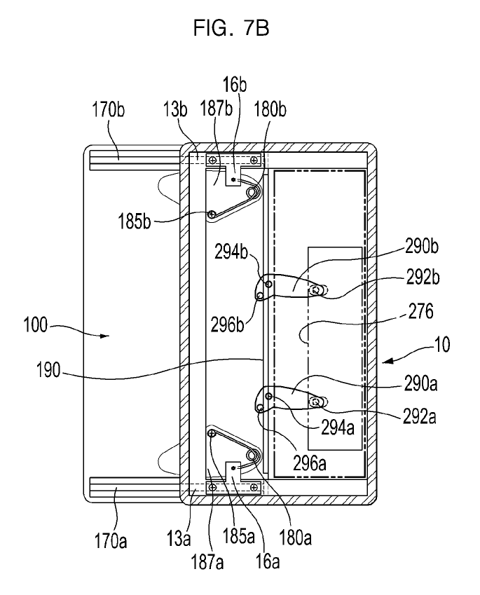

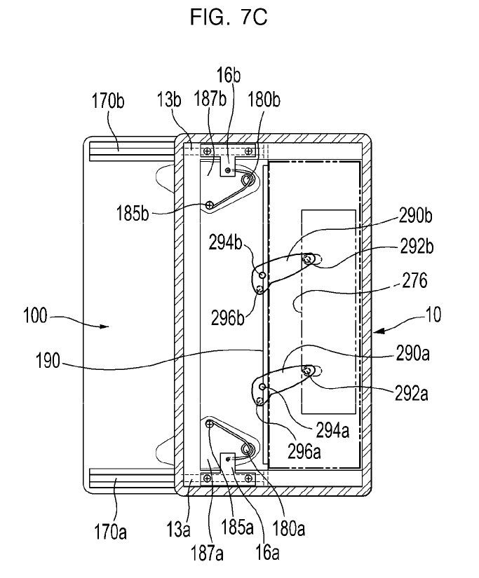

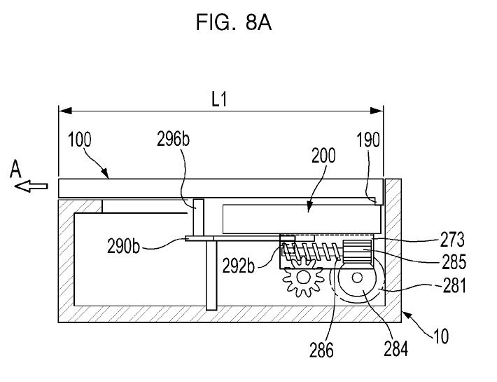

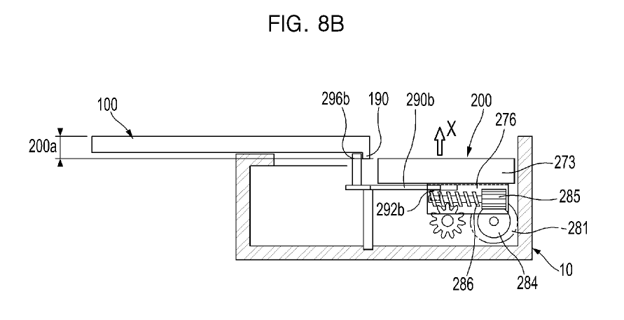

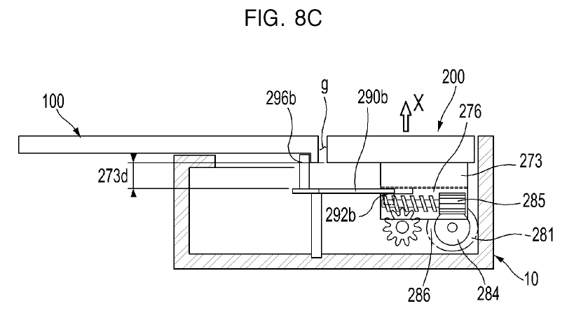

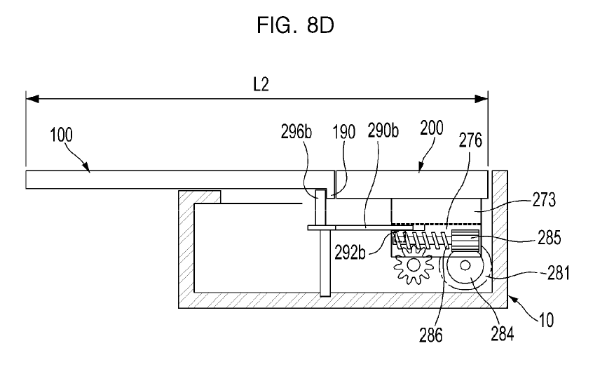

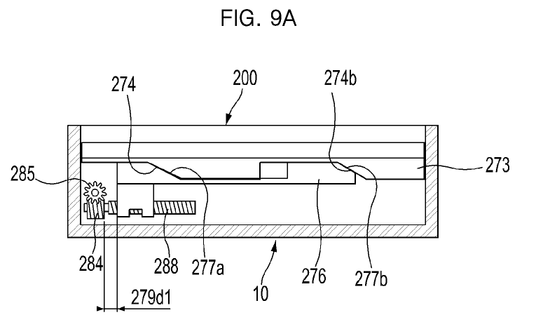

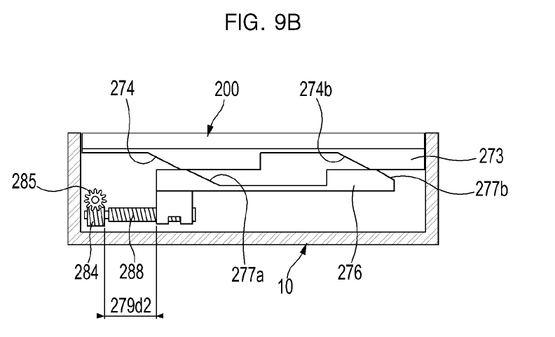

FIGS. 6A to 6C are exterior perspective views illustrating a sequence of up-sliding motions of a main display unit, FIGS. 7A to 7C are sectional views illustrating the sequence of up-sliding motions of the main display unit when viewed from line I-I′ of FIG. 1, FIGS. 8A to 8D are sectional views illustrating the sequence of up-sliding motions of the main display unit when viewed from line II-II′ of FIG. 1, and FIGS. 9A and 9B are sectional views illustrating the sequence of up-sliding motions of the main display unit when viewed from line III-III′ of FIG. 1.

As illustrated in FIGS. 6A, 7A, 8A, and 9A, the sub display unit may not be exposed in a state in which the main display unit 100 is slid down, and therefore, a user watches only a screen of the main display unit 100 having a length L1, as illustrated in FIG. 8A. That is, only the main display unit 100 may be disposed at the front of the case 10.

When the user slides the main display unit 100 up in an “A” direction, as illustrated in FIGS. 6B, 7B, and 8B, the main display unit 100 may be kept slid up by elastic force of the springs 180a and 180b. Distance 200A in FIG. 8B represents the distance which the sub display unit 200 must travel in the “X” direction to lie flush with the main display unit 100.

After up-sliding of the main display unit 100, a controller (not illustrated) controls the motor 281 to be operated, and drive force from the motor 281 may be transmitted to the rear cam 276 via the power transmission unit 283. As a result, the rear cam 276 may perform a rectilinear motion. At this time, the inclines 274a and 274b of the front cam 273 ride over the inclines 277a and 277b of the rear cam 276, with the result that the sub display unit 200 rises in an “X direction (FIGS. 6C, 8C, and 9C).

Simultaneously with the rising of the sub display unit 200, the lever units 290a and 290b may be rotated about the stationary pins 294a and 294b by the rectilinear motion of the rear cam 276. As a result, the rotary pins 296a and 296b of the lever units 290a and 290b pull the main display unit 100 to the sub display unit 200 while contacting the lever protrusion 190. Consequently, a gap g, occurring in FIG. 8C, disappears, as illustrated in FIG. 8D. Distance 273d, illustrated in FIG. 8C, represents the distance the front cam 273 travels in the “A” direction in order for the sub display unit 200 to lie flush and side by side with the main display unit 100.

FIG. 9A illustrates the distance 279d1 between the nut 279 and first gear 284 when the sub display unit is not exposed. FIG. 9B illustrates the distance 279d2 between the nut 279 and first gear 284 after up-sliding of the main display unit 100.

In the end, the main display unit 100 and the sub display unit 200 are arranged side by side to constitute a single display screen having a length L2, as illustrated in FIG. 8B. That is, the main display unit 100 and the sub display unit 200 may constitute a large display screen at the front of the case 10.

The gap g between the main display unit 100 and the sub display unit 200 during rising of the sub display unit 200, and the main display unit 100 and the sub display unit 200 constituting a single homogeneous screen may occur by the provision of the lever units 290a and 290b.

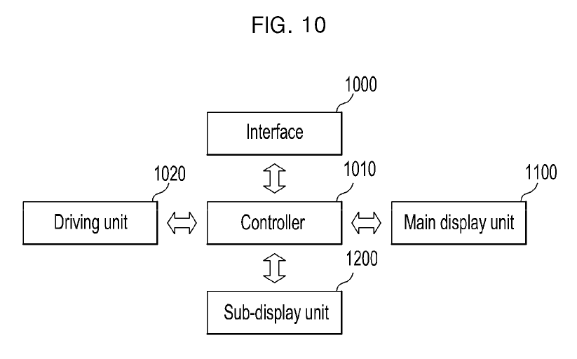

Additionally, FIG. 10 illustrates a controller 1010 in the present general inventive concept that controls an interface 1000, a driving unit 1020, a main display unit 1100, and a sub display unit 1200. The flow of control between the controller 1010 and each of the interface 1000, driving unit 1020, main display unit 1100, and sub display unit 1200 is bi-directional. Further, the interface 1000 may constitute a user interface wherein a user may provide input through, for example, a USB port. The driving unit 1020 is controlled by controller 1010 to move at least one of the main display unit 1100 and the sub-display unit 1200 with respect to the case 10. The driving unit 1020 may include one or more units to move the main display unit 1100 and/or sub-display unit 1200 such that screens of the main display unit 1100 and the sub-display unit 1200 can be disposed on a plane to display an image thereon. The interface 1000 may communicate with a user or an external device to display an image in a first mode using the main display unit 1100 or a second mode using the sub-display unit 1200. The controller 1010 generates a signal representing an image to be displayed on a single screen of the main display unit 1100 or plural screens of the main display unit 1100 and the sub-display unit 1200. The controller 1010 generates a first signal to the main display unit 1100 to display the image on the main display unit 1100 in a first mode, and a second signal to the main display unit 1100 to display a portion of the image on the screen of the main display unit 1100 and a third signal to the sub-display unit 1200 to display another portion of the image on a screen of the sub-display unit 1200 such that an image can be displayed on screens of the main display unit 100 and the sub-display unit 1200 in a second mode.

Hereinafter, change in operation modes of the complex entertainment apparatus 1 according to up-sliding and down-sliding motions of the main display unit 100 will be described.

Operation modes of the complex entertainment apparatus 1 may include a picture mode in which still pictures or motion pictures are captured, a playback mode in which still pictures or motion pictures are played on a screen of the display apparatus, and a game mode in which games are played on the screen.

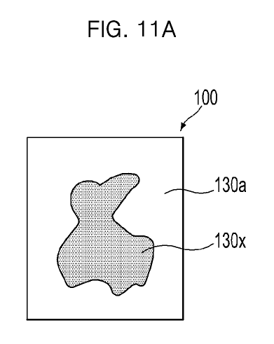

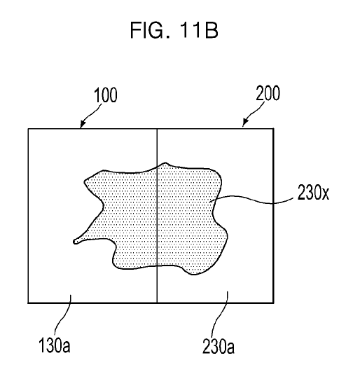

In a state in which the main display unit 100 is slid down as illustrated in FIG. 11A, the complex entertainment apparatus 1 may be operated in the picture mode. In a state in which the main display unit 100 is slid up as illustrated in FIG. 11B, the complex entertainment apparatus 1 may be operated in the playback mode or the game mode.

That is, the size of the display screen may be decreased when a user carries the complex entertainment apparatus 1 and takes still pictures or motion pictures. Consequently, the complex entertainment apparatus 1 may be operated in the picture mode in a state in which the main display unit 100 is slid down. On the other hand, the size of the display screen may be increased when the user plays still pictures or motion pictures or plays games. Consequently, the complex entertainment apparatus 1 may be operated in the playback mode or the game mode in a state in which the main display unit 100 is slid up.

For example, in FIG. 11A, the main display module 130 of the main display unit 100 displays an image 130x when the image display unit 100 is slid down. In FIG. 11B, the main display unit is slid up, wherein the main display module 130 combines display screens with the sub display module 230 of the sub display unit 200 to form a single display screen displaying an image 230x thereon. Note, the display screen to display corresponding portions of the image on which image 130x is displayed is smaller than the display screen on which image 230x is displayed. Hence, the size of the display screen may be increased when the user slides up the main display unit 100.

In the game mode, user-controllable button icons may be displayed on the screen of the sub display unit 200 such that the user enjoys games on a large screen. In this case, two-player games may be played.

Also, when the main display unit 100 is slid up while the complex entertainment apparatus 1 is operated in the picture mode, the operation mode is automatically switched to the playback mode or the game mode.

When the main display unit 100 is slid up in a state in which the complex entertainment apparatus 1 is off, the complex entertainment apparatus 1 may be automatically turned on and operated in the playback mode or the game mode.

Also, when the main display unit 100 is slid down while the complex entertainment apparatus 1 is operated in the playback mode or the game mode, the complex entertainment apparatus 1 may be automatically turned off.

As is apparent from the above description, the display apparatus may include a main display unit and a sub display unit. Consequently, the size of a screen of the display apparatus may be varied.

Also, the occurrence of a gap between the main display unit and the sub display unit is prevented when the size of the screen of the display apparatus is increased.

Also, the operation mode of the complex entertainment apparatus may be changed in correspondence to the size of the screen of the display apparatus according to up-sliding and down-sliding motions of the main display unit, thereby satisfying user demand.

Although a few exemplary embodiments of the present general inventive concept have been illustrated and described, it would be appreciated by those skilled in the art that changes may be made in these exemplary embodiments without departing from the principles and spirit of the general inventive concept, the scope of which is defined in the claims and their equivalents.

What is claimed is:

1. A display apparatus comprising:
a case;
a main display unit to slide at one surface of the case;
a sub display unit to move frontward to the surface of the case or move rearward from the surface of the case; and
a display coupling unit to move the main display unit to the sub display unit on the surface of the case.

2. The display apparatus according to claim 1, further comprising:
an elevation unit to elevate the sub display unit, wherein the elevation unit comprises:
a front cam formed at a rear of the sub display unit and a rear cam disposed at a rear of the front cam.

3. The display apparatus according to claim 2, wherein the display coupling unit comprises:
at least one lever unit to be rotated by a rectilinear motion of the rear cam.

4. The display apparatus according to claim 3, wherein the lever unit comprises:
a drive pin coupled to the rear cam, a stationary pin coupled to the case, and a rotary pin to pull the main display unit to the sub display unit.

5. The display apparatus according to claim 4, wherein the rotary pin is caught by a lever protrusion formed at a lower side of a rear of the main display unit.

6. The display apparatus according to claim 2, wherein
the front and rear cams have corresponding inclines, and
the front cam is moved frontward or rearward by a rectilinear motion of the rear cam.

7. The display apparatus according to claim 6, further comprising:
a drive unit to rectilinearly move the rear cam, wherein
the drive unit comprises:
a motor to provide drive force and a power transmission unit to transmit the drive force provided by the motor to the rear cam.

8. The display apparatus according to claim 7, wherein the power transmission unit comprises:
a plurality of gears and screws.

9. The display apparatus according to claim 8, wherein the power transmission unit comprises:
a first gear directly connected to the motor, a second gear engaged with the first gear such that a rotation axis of the second gear is perpendicular to that of the first gear, a first screw having the same rotation axis as the second gear, a third gear engaged with the first screw such that a rotation axis of the third gear is perpendicular to that of the first screw, and a second screw having the same rotation axis as the third gear to directly transmit drive force to the rear cam.

10. The display apparatus according to claim 1, wherein the main display unit comprises:
an anti-slip part to prevent slip during sliding of the main display unit.

11. The display apparatus according to claim 1, wherein the main display unit is provided at a rear thereof with a spring to connect the main display unit and the case.

12. The display apparatus according to claim 11, wherein the spring comprises a spiral spring.

13. The display apparatus according to claim 1, wherein
the main display unit is provided at opposite sides of a rear thereof with slide bars, and
the case comprises:
guide rails to guide sliding motions of the slide bars.

14. A display apparatus comprising:
a case;
a main display unit constituting a screen;
a sub display unit to move to one side of the main display unit according to movement of the main display unit such that the main display unit and the sub display unit are arranged side by side; and
a lever unit to connect the main display unit and the sub display unit, wherein
the lever unit moves the main display unit to the sub display unit during movement of the sub display unit.

15. A display apparatus comprising:
a case;
a main display unit to slide on one surface of the case in a first direction;
a sub display unit to move frontward and rearward in a second direction perpendicular to the first direction; and
a gap restraint part disposed with at least one of the main and sub display units to restrain occurrence of a gap between the main display unit and the sub display unit when the main display unit and the sub display unit constitute the same plane.

16. A complex entertainment apparatus comprising:
a display apparatus constituting a screen, wherein the display apparatus comprises:
a main display unit to slide in a first direction and a sub display unit to move frontward and rearward in a second direction perpendicular to the first direction, and
the complex entertainment apparatus has operation modes changeable according to a sliding motion of the main display unit.

17. The complex entertainment apparatus according to claim 16, wherein the operation modes comprise:
a picture mode in which still pictures or motion pictures are captured, a playback mode in which still pictures or motion pictures are played on the screen of the display apparatus, and a game mode in which games are played on the screen.

18. The complex entertainment apparatus according to claim 17, wherein the complex entertainment apparatus is operated in the picture mode in a state in which the main display unit is slid down and in the playback mode or the game mode in a state in which the main display unit is slid up.

19. The complex entertainment apparatus according to claim 17, wherein the complex entertainment apparatus is automatically turned on and operated in the playback mode or the game mode when the main display unit is slid up in a state in which the complex entertainment apparatus is off.

20. The complex entertainment apparatus according to claim 17, wherein the complex entertainment apparatus is automatically turned off when the main display unit is slid down while the complex entertainment apparatus is operated in the playback mode or the game mode.

21. The complex entertainment apparatus according to claim 18, wherein the operation mode is switched to the playback mode or the game mode when the main display unit is slid up while the complex entertainment apparatus is operated in the picture mode.

22. An interactive image display apparatus comprising:
a case;
a main display unit to display at least one image in a picture mode while aligned with the perimeter of the case;
a sub display unit to display at least one image in a playback or game mode while positioned on a plane shared with the main display unit; and
a drive unit to power at least one cam to move the sub display unit in a direction perpendicular the plane shared with the main display unit.

23. The interactive image display apparatus of claim 22, wherein the at least one cam travels on a straight path perpendicular to the direction to move the sub display unit to the playback or game modes.

24. The interactive image display apparatus of claim 22, wherein the still pictures or motion pictures are captured in the picture mode while still pictures or motion pictures are interactively displayed in the playback and game modes.

25. The interactive image display apparatus of claim 22, wherein the main display unit and sub display unit comprises:
a screen to display still pictures or motion pictures thereon in the playback and game modes.

26. A display device comprising:
a case;
a main display unit to display an image thereon and to slide in a lengthwise direction;
a sub display unit to display an image thereon and to travel in a vertical direction perpendicular to the lengthwise direction; and
a pair of cams to move the sub display unit in the vertical direction in order to position an edge of the sub display unit flush with an edge of the main display unit.

27. The display device of claim 26, wherein the display device further comprises operational modes comprising:
a gaming console mode when an edge of the sub display unit is arranged flush with an edge of the main display unit, and
a picture viewer mode when the main display unit is positioned above the sub display unit.

28. A display apparatus comprising:
a case;
a plurality of display units having their respective screens to display an image thereon; and
a driving unit to drive the plurality of display units with respect to the case such that the respective screens are disposed on a plane to display the image.

29. The display apparatus of claim 28, wherein the plurality of display units comprises:
a first display unit to display the image in a first mode, and a second display unit to display the image together with the screen of the first display unit in a second mode.

30. The display apparatus of claim 28, wherein one of the plurality of display units displays the image in a first mode, and the plurality of display units display corresponding portions of the image on respective screens of the display units in a second mode to display the image.

31. The display apparatus of claim 28, wherein the driving unit comprises:
a first unit to move one of the display units in a first direction, and a second unit to move the other one of the display units in the first direction and a second direction.

32. The display apparatus of claim 28, wherein the plurality of display units have corresponding sizes of screens, and the screens of the display units are combined to have a new size of a new screen to display an image thereon.
